(19) United States
(12) Patent Application Publication
(10) Pub. No.: US 2006/0026237 A1
(43) Pub. Date: Feb. 2, 2006

(54) Method and system for instant message using HTTP URL technology

(76) Inventors: Richard Gaohua Wang, Bradenton, FL (US); Disheng Zhang, Shenzhen (CN)

Correspondence Address: RICHARD G. H. WANG, 1903 60TH PLACE, SUITE M1145, BRADENTON, FL, 34203, US

(21) Appl. No.: 10/710,746

(22) Filed: Jul. 30, 2004

(51) Int. Cl. G06F 15/16

(52) U.S. Cl. 709/206; 709/217

(57) ABSTRACT

A method, system, means, and computer program code for providing instant message service. According to embodiments of the present invention, each instant message user has a HTTP URL as its unique identification. When the sender wants to chat with the receiver, just enter the receiver's URL for Instant Message in any Internet browser like surfing a website using any Internet access device, if the receiver is online, then they can chat to each other. Both parties do not have to download and install any instant message client software on their computers and not necessarily to know which instant message software the receiver is using. If the receiver is offline, then the sender can leave message to the receiver. The system can then forward the sender's message to receiver's email account or mobile device. Enterprise user can use the URL for Instant Message to provide live help for its customer and its website visitor. The mobile phone user can use any mobile phone that embeds Internet browser to use instant message service, no any instant message client software to be embedded in mobile phone.

### BACKGROUND OF INVENTION

Instant message is becoming the primary means of communications for many people, both for personal and enterprise communication purposes. In a typical instant message system, a user required to obtain a unique identification (UID) from the instant message service provider, the UID may be a number like 41308881 for ICQ, or an email account like “wotone@msn.com” for MSN Messenger. Before the user can start using the instant message service they also need to download and install instant message client software on the user's device (e.g., computer, personal digital assistant). The client software will create a connection with the instant message server when the user logs on to the Internet. If user A wants to communicate with user B, user A must know which instant message service provider that user B is using. User A must also has a UID from the same instant message service provider, download and install the same client software on his/her computer and add user B to his/her contact list in order to successfully communicate with user B.

All current instant message service provider like ICQ, MSN, Yahoo are using the similar instant message process system described in above paragraph, there are four problems for current instant message service: First, user need to download and install a instant message client software. This not only occupies computer resource and Internet bandwidth, but also limited the use of instant message through any Internet access device anywhere anytime. Second, each instant message service provider's system is independent to each other and exchange of instant message between different service providers cannot be easily achieved. All the parties wish to communicate to each other must install the same instant message client software. If someone wants to communicate with users on a number of different instant message service providers, he/she must register and install each instant message service provider's client software on his/her computer. According to some instant message market report, most instant message user install more than two client software on his/her computer. Third, the current instant message solution is not suitable for mobile instant message application since it need to embed instant message client software in mobile phone. Each software will take up valuable resource on the mobile device hence it's not very practical to embed too many instant message client software on the mobile device, so if one mobile phone embed one instant message service provider client software and another mobile embed another instant message service provider client software, then the two mobile user cannot use them to communicate with each other using mobile instant message service. These greatly affected the application of mobile instant message service on the mobile devices. Fourth, current instant message system is designed for personal instant communication need, not for enterprise need, enterprise IM is a separate system. Additional, current email system have many problems to deal with junk mail and virus broadcast through email, there is no good solution for that problem now.

It would be a revolution to provide a new method and system that overcomes the drawbacks described in the above paragraphs. In particular, this invention is aim to overcome the problem that the different Instant Message service provider can not exchange the instant message as well as remove the need to download and install specific instant message client software.

### SUMMARY OF INVENTION

Embodiments of the present invention provide an instant message system, method, means that the instant message user's identification is a unique HTTP URL (Uniform Resource Locator) that any Internet browser can visit.

Additional advantages and novel features of the invention shall be set forth in part in the description that follows, and in part will become apparent to those skilled in the art upon examination of the following or may be learned by the practice of the invention.

According to some embodiments of the present invention, each instant message user has a unique HTTP URL for Instant Message, there are no need to download and install any software to use instant message service both for sender and receiver. The user enters its own URL for Instant message in any Internet browser to logon and indicate he/she is online. If someone wants to communicate with another one that has URL for Instant Message, all it needs to do is to type in the receiver's URL for Instant Message in any Internet browser, just like surfing a website, then they can chat together if the receiver registered online.

According to some embodiments of the present invention, if the receiver's status is offline, when a conversation request is made by another party, the system is also capable of detecting if the receiver is using any other instant message services and forward the request to the receiving party. Alternatively, the receiving party can be notified by email or by SMS to the mobile device.

According to some embodiments of the present invention, there is no need to embed a instant message client software in mobile phone for mobile instant message application, mobile user can use any mobile phone with Internet access to chat with mobile instant message user and PC-based instant message user. If the mobile phone don't support internet access, then mobile user can use SMS to chat with other instant message user.

According to some embodiments of the present invention, the user that have URL for Instant Message can use the URL as a new type of email account, refer to as URL for Email. Any one can send messages to the user and the user can manage the messages by login to his/her URL for Email account as well as sending email to traditional email account.

According to some embodiments of the present invention, any entity can use the URL for Instant Message as a new communication tool like telephone. Anyone that wants to contact the company that have URL for Instant Message can just enter the entity's URL for Instant Message in the Internet browser to get instant help from this company. We named this is Enterprise Application. The enterprise user can use the URL in its website to provide live help service for its customer and website visitor, any one visit the website and click the URL for Instant Message hyperlink that embedded in the website, can instantly get response from the website live help operator and can chat with the website customer support person to get help.

According to some embodiments of the present invention, the enterprise user can apply a web page Monitor URL in the same sub-domain with the URL for Instant Message, and embed the Monitor URL to any web page that want to be monitored, then the live help operator can monitor which page is surfing by the website visitor and can invite the visitor for chat to provide live person help. If the live help operator is offline, then the live help button will be changed to offline status, the visitor can leave message to the user URL for Instant Message account or forward to its Email account.

According to some embodiments of the present invention, the instant message user could use this instant message service to communicate online by using text message, voice chat and video conference. The service can also be extended to collaborate with colleagues as we as play online games.

According to some embodiments of the present invention, the user can have its own domain name and assign a URL for instant message service using its own domain name, only need to change its domain name's DNS server to the URL for Instant Message service provider's DNS server.

With these and other advantages and features of the invention that will become hereinafter apparent, the nature of the invention may be more clearly understood by reference to the following detailed description of the invention, and to the several drawings attached herein.

### BRIEF DESCRIPTION OF DRAWINGS

The accompanying drawings, which are incorporated in and form a part of the specification, illustrate the preferred embodiments of the present invention, and together with the descriptions serve to explain the principles of the invention.

FIG. 1 is a flowchart of the instant message system using URL for Instant Message process method in accordance with the present invention.

### DETAILED DESCRIPTION

Applicant has recognized that there is a need for systems, means, computer program code and methods that process the instant message service. The key factor for this invention is the instant message user unique identification. The user unique identification (UID) used by current instant message service provider is a number like ICQ or an email account like MSN Messenger and Yahoo Messenger. The limitation of the current services is that all of them are closed system, that means the user of one service provider cannot communicate directly with the user in another different service provider. Our solution is to assign a HTTP URL to the instant message user as the UID. For example, the service provider domain name is “urlim.com”, then User A's URL for Instant Message is “www.userA.urlim.com”, or “userA.urlim.com” or a independent domain name like “userA.com” as its URL for Instant Message. User A can just let other people know that his/her instant message URL is usera.urlim.com just like telling others the website URL. However, in the current situation, if he/she is using ICQ, he/she will need to let other people know that he/she is using ICQ as instant message service provider and his/her ICQ number is 41308881, for example. This just like when you telling your friend about your telephone number, you have to let them know what telephone company you are using. If your friends are using different telephone networks, they will not be able to call you unless they also use the same telephone company. This invention will make instant message a lot simpler than it is now. This invention can also add value to enterprise users. For enterprise user, system will assign a URL like “livehelp.usera.urlim.com” for live help service, and assign a URL like “monitor.usera.urlim.com” for web pages monitor URL. The user can apply a URL like “google.usera.urlim.com” for its Google Adwords link. The user can apply multi sub-domain URL for many purposes guided by the HTTP URL rules. Of course, user can apply any domain name he/she likes if the instant message service provider can accepted his/her domain name. These and other features will be discussed in further detail below, by describing a system and processes according to embodiments of the invention.

### PROCESS DESCRIPTION

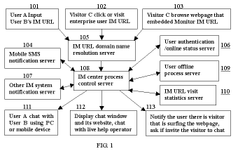

Reference is now made to FIG. 1, where a flow chart is shown which represents an operation of a first embodiment of the present invention. The particular arrangement of elements in the flow chart is not meant to imply a fixed order to the steps; embodiments of the present invention can be practiced in any order that is practicable. In some embodiments, the process method is particularly well suited for implementation by or on a personal instant message user and a enterprise instant message user, as will be discussed in more detail below.

For personal user, processing begins at a step 101, the sender-User A want to chat with User B, so User A enters User B's URL for Instant Message (URLIM) in his/her Internet browser. The DNS server for User A's ISP (Internet Service Provider) will resolute User B's URL for Instant Message from 105 (IM URL domain name resolution server). 105 then pass the request to 108 (IM center process control server). 108 will check if User B is a registered user and check its online status in 106 (user authentication/online status server). If User B is a registered user and he/she is online, then 108 display the chat window for User A and inform User B is online now and waiting for User B's response at the same time 108 notify User B that User A wish to talk with him/her. If User B accept the chat request, then the communication can start between User A and User B (111). That is the completely cycle of the process. User A only use Internet browser to input User B's URL for Instant Message, no client software is needed to be installed on User A's computer, and further more, User A even do not necessarily to have the URL for Instant Message.

As previously mentioned above, if 106 informs 108 that User B is offline, then 108 will request 107 (Other IM system notification server) to check if User B is using any other instant message service, if yes and online, then a notification will be sent to User B to inform him/her that someone want to establish a communication by visiting User B's URL for Instant Message. If User B is not using any IM service online, then 108 pass the request to 109 (User offline process server) to let User A leave message to User B's account. The message can then be forwarded to User B's Email account if set. Alternatively, if User B set a mobile phone SMS notification option, then 108 will request 104 (Mobile phone SMS notification server) to send a SMS to User B's mobile phone.

For enterprise user, the user can use the URL for Instant Message as its public communication tool. Any one wants to contact this entity can just enter its URL for Instant Message in any Internet browser and chat with the live help operator. Processing begins at a step 102, Visitor C or named as potential Customer C want to contact enterprise user—entity User D. Visitor C enters User D's URL for Instant Message (URLIM) in his/her Internet browser or click the “Live Help” hyperlink that embedded the Live Help URL for Instant Message on Entity D's website like “livehelp.entityD.urlim.com”. The DNS server of Visitor C's ISP will resolute the Entity D's URL from 105 (IM URL domain name resolution server). 105 then pass the request to 108 (IM center process control server). 108 will check if Entity D is a registered user and check its online status in 106 (user authentication/online status server). If Entity D is a registered user and Entity D's operator (the live help person) is online, then 108 display the chat window for Visitor C and inform the operator is online now waiting for operator's response, at the same time, 108 notify the operator that there is Visitor D want to get help and clicked the URL for Instant Message. If the operator accepts the chat request, then Visitor C can chat with the operator (112) with another window that display Entity D's product/service web page. That is the completely cycle of the process for enterprise user. Visitor C only uses Internet browser to establish the instant message communication with Entity D. No client software needs to be installed on Visitor C's computer, and also no client software need to be install for Entity D's operator. Of course, to make the operator manage a lot of URLIM request efficiently, an operator client software can be used.

As previously mentioned above, if 106 notifies 108 that Entity D's operator is offline, the whole process is like the personal user process described in about paragraph. But for enterprise user, the different is that the system will automatic import all online chat visitor or offline leave message user's information to CRM (Customer Relationship Management) database for enterprise user manage its exist customer and potential customer.

For enterprise user, combined with live help service using Live Help URL for Instant Message, the entity can embed a web page monitor URL in its website. Any web pages can embed the Monitor URLIM like “monitor.entityD.urlim.com”. When Visitor C browsed the web page that embedded Monitor URLIM (103), Visitor C's ISP's DNS server will resolute the Entity D's Monitor URL from 105 (IM URL domain name resolution server). 105 pass the request to 108 (IM center process control server). 108 will check if Entity D is a registered user and check its online status in 106 (user authentication/online status server). If Entity D is a registered user and Entity D's operator (the live help person) is online, then 108 will notify the Entity D operator that there is visitor is surfing the web page (113) and ask if the operator wish to invite the visitor to have a chat to provide live help for the visitor.

As shown by the examples above, for both personal user and enterprise user, the system provide URL for Instant Message visited statistics service (110). 110 will let the user check the visited statistics for the user's all URLs since the enterprise user can apply many URLIM for different marketing service. For example, Entity D couldl apply a URLIM for search engine marketing campaign like Google Adwords as “google.entityD.urlim.com”. When potential buyer search the search engine and click the campaign advertisement, it not only link to its website, but will also display a live help windows. This will greatly improve the campaign result and attract more customers. And the enterprise user can use the statistics report for all URLs to know each marketing method's result.

As previously mentioned above, if the user want to be online, just need to enter its own URLIM in any browser, it will display a login interface in this page, user enter its password and the auto-generated pictured password, then the user is registered as online and minimize the login page to stay online.

The user that has URL for Instant Message can use the URL as URL for Email, an alternative email account. Anyone can leave message to its account, and user can log on to its own account to check the message and can reply to the sender's URLIM or traditional email account. So the URLIM combined Email function, only one URL is enough for Internet communication. Use URL for Instant Message as alternative email account has advantage compare to the current “traditional” email. URL for Instant Message can stop the spreading of SPAM and virus. The user can use web or mail client software to send/receive/manage message in his/her account. According this usage, URLIM can explain as “URL for Internet Message”, the Internet Message includes Instant Message and Email.

As previously mentioned above, URL Instant Message not only limited to text chat but also support audio chat and vide conference or even PC to telephone call. Users can also collaborate for work and network games etc. The URL will become the unique portal for all Internet communication needs.

If user wants to use its own exist domain name like “companyname.com” to act as URL for Instant Message. They only need to change the domain name's DNS server to URLIM's DNS server (105). For example, the normal website URL is “www.companyname.com”, and its URL for Instant Message will be “im.companyname.com”; live help service URL will be “livehelp.companyname.com” and Monitor URL will be “monitor.companyname.com”. For its employees, for example, Jason, his URL for Instant Message is “jason.companyname.com” and for sales department URL for Instant Message is “sales.companyname.com”. The URL can be used for the purpose of Instant Message and Email that discussed above.

The methods of the present invention can bind mobile phone number with URLIM, for example, if the mobile carrier's domain name is “carrierA.com”, and its customer mobile phone number is 13901012345, then this mobile phone number's URL for Mobile Instant Message is “13901012345.carrA.com” or directly is “13901012345.com”. Mobile phone user can use any mobile phone that can access the Internet with browser to chat with anyone that also have URL for Instant Message no matter the other party is using mobile phone or computer.

The methods of the present invention may be embodied as a solution for instant message that using URL as instant message service identification, named URLIM, and user can use this URL for instant message service and live help service. However, it would be understood that the invention as described herein could be implemented in many different ways for other application. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single system, multi-system, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method for processing of an instant message by utilizing HTTP URL technology, comprising: Each instant message user has a globally unique HTTP URL as its identification, refer to as URL for Instant Message. When the sender wants to communicate with the receiver, just enters the receiver's URL for Instant Message in any Internet browser like surfing a website. If the receiver is online, they will then be able to communicate with each other. There is no need to download and install any client software on the sender and receiver's computer. Either party does not necessarily need to know which instant message client software the other party is using.

2. The method of claim 1, wherein said the instant message user's identification is not a number or email account obtained from instant message service provider in a closed system. It is a HTTP URL that can be visited by using any Internet access device with Internet browser.

3. The method of claim 1, wherein said there are no need to download and install any instant message client software on sender's and receiver's computer in order to use instant message service.

4. The method of claim 1, wherein said the instant message user could enter his/her own URL for Instant message in any Internet browser and login to indicate he/she is online.

5. The method of claim 1, wherein said when the sender of instant message wants to initialize a conversation with some one else that has URL for Instant Message, the sender just enter the receiver's URL for Instant Message in any Internet browser no matter if the sender has URL for Instant Message. If the receiver is online, they will then be able to communicate with each other using secured connection.

6. The method of claim 1, wherein said if the receiver's status is offline, when a conversation request is made by another party, the system is also capable of detecting if the receiver is using any other instant message services and forward the request to the receiving party. Alternatively, the receiving party can be notified by email or by SMS to the mobile device.

7. The method of claim 1, wherein said the user that can have its own domain name and assign a URL for instant message service using its own domain name, only need to change its domain name's DNS server to the URL for Instant Message service provider's DNS server.

8. The method of claim 1, wherein said user could use this instant message service to communicate online by using text message, voice chat and video conference. The service can also be extended to collaborate with colleagues as well as play online games.

9. The method of claim 1, further comprising: using URL for Instant Message to provide live help service for enterprise user. The enterprise user can use the URL as a public communication tool and provide live help service for its customers and its website visitors. Any one visits its website can instantly get response from the website live help operator or customer support person by simply clicking the URL for Instant Message hyperlink that embedded in the website.

10. The method of claim 9, wherein said the instant message enterprise user can provide a live help service by embedded the URL for Instant Message in their website. When visiting the website, help can be easily accessed by clicking on the live help hyper link to URL for Instant Message.

11. The method of claim 9, wherein said the instant message enterprise user can apply a web page Monitor URL and embed the Monitor URL to any web page that want to be monitored, then the live help operator can monitor which page is surfing by the website visitor and can invite the visitor for chat to provide live person help.

12. The method of claim 9, wherein said if the live help operator is offline, then the live help button will be changed to offline status. The visitor can leave message to the operator's URL for Instant Message account or forward to its email account.

13. A method for mobile instant message application using URL for Instant Message, comprising: Every mobile user has a globally unique URL for Mobile Instant Message service. User can use mobile phone that have Internet access and Internet browser to use instant message service. No instant message client software is required to be embedded in mobile phone. Mobile phone user can use instant message service to communicate with other mobile users or computer instant message users.

14. The method of claim 13, wherein said every mobile user has a unique URL as identification for Mobile Instant Message corresponding to its mobile phone number. No instant message client software is required to be embedded in mobile phone. If the mobile phone can use Internet browser to access Internet, then the mobile phone can be used as mobile instant message device.

15. The method of claim 13, wherein said mobile phone user can use instant message communicate with PC-based instant message user or other mobile device user that have URL for Instant Message, both parties do not need to install any instant message client software.

16. The method of claim 13, wherein said if the mobile phone does not support Internet access, then the mobile phone user can still send/receive SMS to/from a URL for Instant Message user no matter if the URL for instant message user is using mobile device or computer.

17. The method of claim 13, wherein said the user that have URL for Mobile Instant Message can user instant message both in mobile phone and computer.

18. The method of claim 13, wherein said if the mobile phone is powered off, all SMS that send to this mobile phone can forward to the user's computer if the user login the URL for Mobile Instant Message in computer.

19. A method for email application using URL for Instant Message, comprising: the user that has URL for Instant Message can use this URL as an alternative to traditional email. Anyone can send message to the user no matter if he/she is online by entering the URL for Instant Message in any Internet browser, and the user can manage the messages by login to his/her URL for Instant Message account as well as sending email to traditional email account.

20. The method of claim 19, wherein said the user can use the URL for Instant Message as URL for Email, no need to have a traditional email account, if someone want to send message to the user, just need to enter the user's URL for Email in the internet browser and leave message online and attach a file, then send to the user's account.

21. The method of claim 19, wherein said the user can check and manage his/her messages by entering his/her URL for Email in the Internet browser and login, or using a URL for Email client software to check and manage its URL for Email account for easily manage its email in local computer.

22. The method of claim 19, wherein said user can use URL for Email system to send/receive email to/from traditional email account on the web-based interface or URL for Email client software.
